(19) United States
(12) Patent Application Publication
(10) Pub. No.: US 2021/0055564 A1
(43) Pub. Date: Feb. 25, 2021

(54) AUGMENTED REALITY DISPLAY DEVICE INCLUDING VISION CORRECTION LENS FOR AUGMENTED REALITY

(71) Applicant: SAMSUNG ELECTRONICS CO., LTD., Suwon-si (KR)

(72) Inventors: Geeyoung SUNG, Daegu (KR); Changkun LEE, Seoul (KR); Hongseok LEE, Seoul (KR)

(73) Assignee: SAMSUNG ELECTRONICS CO., LTD., Suwon-si (KR)

(21) Appl. No.: 16/773,359

(22) Filed: Jan. 27, 2020

(30) Foreign Application Priority Data
Aug. 20, 2019 (KR) 10-2019-0101868

(51) Int. Cl. G02B 27/01; G02C 9/00

(52) U.S. Cl. CPC G02B 27/0176; G02B 2027/0178; G02C 2200/02; G02C 9/00

(57) ABSTRACT

An augmented reality display device including a vision correction lens includes an optical combining element disposed to be inclined with respect to an eyeglass, a virtual image supply unit supplying a virtual image to the optical combining element, and a vision correction lens (frequency clip) disposed to be inclined with respect to the eyeglass. The vision correction lens and the optical combining element may be disposed parallel to each other with the same inclination angle.

### CROSS-REFERENCE TO RELATED APPLICATION

This application is based on and claims priority under 35 U.S.C. § 119 to Korean Patent Application No. 10-2019-0101868, filed on Aug. 20, 2019, in the Korean Intellectual Property Office, the disclosure of which is incorporated by reference herein in its entirety.

### BACKGROUND

### 1. Field

The disclosure relates to an augmented reality (AR) device, and more particularly, to an augmented reality display device including a vision correction lens.

### 2. Description of Related Art

Recently, a lot of technologies related to augmented reality (AR) have been studied. In particular, research has been actively conducted about see-through AR display devices that may simultaneously display an artificial or virtual three dimensional (3D) image and a real-world object in real time without visual fatigue, and related studies and products have been introduced. When people with poor vision use an AR display device, a correction lens (a frequency clip) may be used to correct vision.

### SUMMARY

Provided are augmented reality display devices that provide a relatively high comfort of wearing compared to an augmented reality display device of the related art and include a vision correction lens coupled in a way of reducing a volume of the augmented reality display devices.

Additional aspects will be set forth in part in the description which follows and, in part, will be apparent from the description, or may be learned by practice of embodiments of the disclosure.

In accordance with an aspect of the disclosure, an augmented reality display device includes an eyeglass; an optical combining element disposed to be inclined with respect to the eyeglass; a virtual image supply unit supplying a virtual image to the optical combining element; and a vision correction lens disposed with an inclination angle with respect to the eyeglass.

The vision correction lens and the optical combining element may be disposed parallel to each other.

A coupling portion of the vision correction lens may include a groove.

The optical combining element and the vision correction lens may be coupled to each other via a magnet.

The optical combining element and the vision correction lens may be coupled in a sliding manner.

The eyeglass may include a first eyeglass; and a second eyeglass, the optical combining element may include a first optical combining element corresponding to the first eyeglass; and a second optical combining element corresponding to the second eyeglass, and the vision correction lens may include a first vision correction lens corresponding to the first optical combining element; and a second vision correction lens corresponding to the second optical combining element.

The optical combining element may include a portion parallel to the eyeglass.

The vision correction lens may be mounted on a frame disposed with the inclination angle with respect to the eyeglass, and the frame may include a portion parallel to the eyeglass.

The optical combining element may include a single body optical combining element including the first optical combining element; the second optical combining element; and a connector connecting the first optical combining element to the second optical combining element.

The first vision correction lens and the second vision correction lens may be coupled to the optical combining element independently from each other.

The augmented reality display device may further include a single body frame including a first frame mounted on the first eyeglass; a second frame mounted on the second eyeglass; and a frame connector connecting the first frame to the second frame.

The single body optical combining element and the single body frame may be coupled via a magnet.

The magnet may be embedded within at least one from among the optical combining element and the vision correction lens.

The first vision correction lens and the second vision correction lens may be coupled to the optical combining element independently from each other.

The magnet may be embedded within at least one from among the single body optical combining element and the single body frame.

In accordance with an aspect of the disclosure, an augmented reality display device includes an eyeglass having a corrective focal length; an optical combining element disposed to be inclined with respect to the eyeglass; and a virtual image supply unit supplying a virtual image to the optical combining element.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 is a three-dimensional (3D) view of an augmented reality display device including a vision correction lens according to an embodiment;

FIG. 2 is a right side view of the augmented reality display device of FIG. 1;

FIG. 3 is a 3D view showing a case in which a combiner and a vision correction lens are coupled in a sliding manner in an augmented reality display device including a vision correction lens according to an embodiment;

FIG. 4 is a 3D view showing a state in which the combiner and the vision correction lens of FIG. 3 are combined;

FIG. 5 is a 3D view of another vision correction lens included in an augmented reality display device according to an embodiment;

FIG. 6 is a 3D view showing a state in which the vision correction lens of FIG. 5 is mounted in an augmented reality display device according to an embodiment;

FIG. 7 is a front view of an inner surface of a combiner facing a user's eye included in an augmented reality display device according to an embodiment;

FIG. 8 is a front view of an outer surface of a vision correction lens included in an augmented reality display device according to an embodiment;

FIGS. 9 and 10 are cross-sectional views illustrating a combined state of the combiner of FIG. 7 and the vision correction lens of FIG. 8;

FIG. 11 is a front view illustrating a case in which two combiners corresponding to both eyes are provided as a single body in an augmented reality display device according to an embodiment;

FIG. 12 is a left side view of the combiner of FIG. 11;

FIG. 13 is a front view illustrating a case in which two vision correction lenses corresponding to both eyes are provided in one unit in an augmented reality display device according to an embodiment;

FIG. 14 is a right side view of the two vision correction lenses of FIG. 13;

FIG. 15 is a cross-sectional view illustrating a case in which the single body combiner of FIG. 11 and the single body vision correction lens of FIG. 13 are coupled through an unburied magnet;

FIG. 16 is a cross-sectional view illustrating a case in which the single body combiner of FIG. 11 and the single body vision correction lens of FIG. 13 are coupled through a buried magnet;

FIG. 17 is a cross-sectional view illustrating an augmented reality display device according to an embodiment; and

FIG. 18 is a cross-sectional view of an eye glass in front of a combiner in an augmented reality display device according to various embodiments.

### DETAILED DESCRIPTION

Reference will now be made in detail to embodiments, examples of which are illustrated in the accompanying drawings, wherein like reference numerals refer to like elements throughout. In this regard, embodiments may have different forms and should not be construed as being limited to the descriptions set forth herein. Accordingly, embodiments are merely described below, by referring to the figures, to explain aspects. As used herein, the term “and/or” includes any and all combinations of one or more of the associated listed items. Expressions such as “at least one of,” when preceding a list of elements, modify the entire list of elements and do not modify the individual elements of the list.

Hereinafter, an augmented reality display device including a vision correction lens (a frequency clip) according to an embodiment will be described in detail with reference to the accompanying drawings. In the drawings, thicknesses of layers and regions may be exaggerated for clarity of layers and regions.

The augmented reality display device described herein may be used for a personal see-through-type headset as an eyeglass-type see-through AR device.

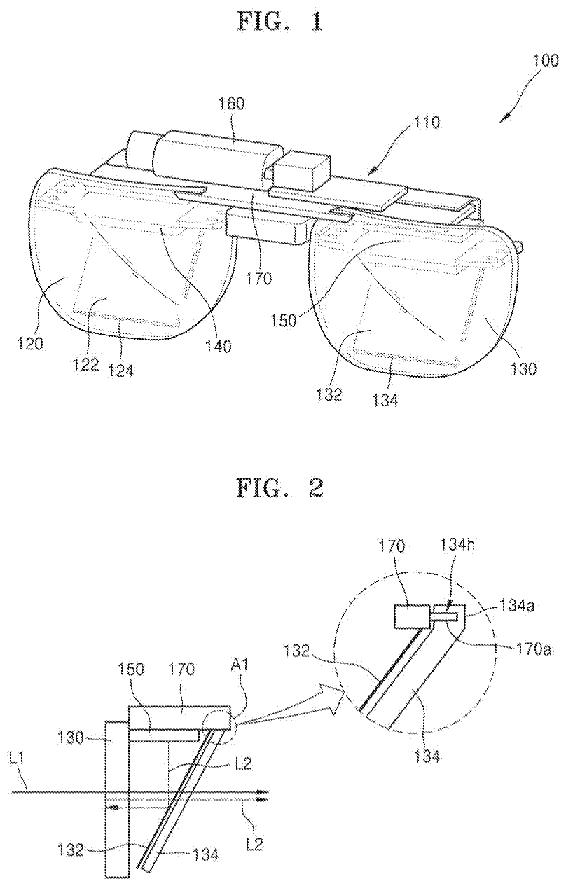

FIG. 1 is a 3D view of an augmented reality display device 100 including a vision correction lens according to an embodiment.

Referring to FIG. 1, the augmented reality display device 100 may include first and second eyeglasses 120 and 130, a virtual image supply device 110, first and second combiners (i.e., first and second optical combining elements) 122 and 132, and first and second vision correction lenses 124 and 134. The augmented reality display device 100 may further include other members that may assist in displaying an augmented reality image. Eyeglass frames worn on the ears may be provided on the augmented reality display device 100. One of the first and second eyeglasses 120 and 130 corresponds to the left eye of a user, and the other corresponds to the right eye of the user. The first and second eyeglasses 120 and 130 may be eyeglasses that have an infinite focal length (i.e., that do not have a corrective function), or eyeglasses that do not function as lenses because the eyeglasses have a uniform thickness. When a user wears the augmented reality display device 100, the first and second combiners 122 and 132 are positioned between the respective first and second eyeglasses 120 and 130 and the user's eyes. The first combiner 122 is provided to make a pair with the first eyeglass 120. The second combiner 132 is provided to make a pair with the second eyeglass 130. The first and second vision correction lenses 124 and 134 are provided for a user who normally wears corrective glasses. When a user who normally wears glasses takes off the glasses and wears the augmented reality display device 100, the user may normally and clearly view the augmented reality image supplied through the augmented reality display device 100 with the aid of the first and second vision correction lenses 124 and 134. That is, since the first and second vision correction lenses 124 and 134 are provided, the supplied augmented reality image is precisely focused on the retina of the user, and thus, the user who normally wears corrective glasses may clearly see the supplied augmented reality image.

When a user wears the augmented reality display device 100, the first and second vision correction lenses 124 and 134 respectively are positioned between the first and second combiners 122 and 132 and the user's eyes as shown, e.g., in FIG. 2. The first vision correction lens 124 is paired with the first combiner 122. The second vision correction lens 134 is paired with the second combiner 132.

The virtual image supply device 110 may be a device capable of supplying a virtual image that may be combined with a real image to a user, or may include such a device. Here, the ‘real image’ means an image of an actual reality that enters the user's eyes. The real image may include images of the user's surrounding environment. The virtual image supply device 110 shown in FIG. 1 is just one example of various devices capable of supplying a virtual image and is simply depicted for convenience of explanation. The virtual image supply device 110 may include a virtual image supply unit 160 and first and second virtual image projectors 140 and 150. The virtual image supply unit 160 supplies a two-dimensional (2D) or a 3D virtual image to the first and second virtual image projectors 140 and 150 that may be combined with a real image. The first and second virtual image projectors 140 and 150 respectively project virtual images supplied from the virtual image supply unit 160 to the first and second combiners 122 and 132. The virtual image supply device 110 may be mounted on a holder 170. The virtual image supply unit 160 may be disposed above the holder 170, and the first and second virtual image projectors 140 and 150 may be disposed below the holder 170. A virtual image projection surface of the first virtual image projector 140 may be disposed to face the first combiner 122. A virtual image projection surface of the second virtual image projector 150 may be disposed to face the second combiner 132. The first and second eyeglasses 120 and 130 and the first and second combiners 122 and 132 may also be supported by the holder 170. The holder 170 may be a main frame of the augmented reality display device 100.

FIG. 2 is a right side view of the augmented reality display device 100 of FIG. 1. For convenience, the virtual image supply unit 160 disposed on the holder 170 as shown in FIG. 1 is omitted from FIG. 2.

Referring to FIG. 2, the second combiner 132 is disposed to be inclined with respect to the second eyeglass 130. As an example, the second combiner 132 may have an inclination angle of about 35° with respect to a plane perpendicular to the second eyeglass 130. A lower end of the second combiner 132 is closer to a lower end of the second eyeglass 130 than an upper end of the second combiner 132 as shown in FIG. 2. A gap between the lower end of the second combiner 132 and the lower end of the second eyeglass 130 is less than a gap between the upper end of the second combiner 132 and the upper end of the second eyeglass 130. The second virtual image projector 150 is mounted on a bottom surface of the holder 170. The second virtual image projector 150 is disposed between the upper end of the second eyeglass 130 and the upper end of the second combiner 132. A virtual image L2 projected by the second virtual image projector 150 is projected on the second combiner 132. The virtual image L2 projected on the second combiner 132 is reflected from the second combiner 132 to the second eyeglass 130. The virtual image L2 reflected by the second combiner 132 is then reflected by the second eyeglass 130 back towards the second combiner 132. The virtual image L2 reflected by the second eyeglass 130 may be reflected from a front surface of the second eyeglass 130 that is farthest from the second combiner 132. The virtual image L2 reflected to a rear of the second eyeglass 130, that is, the virtual image L2 reflected from the second eyeglass 130 to the second combiner 132, enters the user's eyes after sequentially passing through the second combiner 132 and the second vision correction lens 134. At this point, an actual image L1 incident through the second eyeglass 130 also enters the user's eyes after sequentially passing through the second combiner 132 and the second vision correction lens 134. As a result, the real image L1 together with the virtual image L2 enter the eyes of the user, and thus, the user may view an augmented reality image in which the real image L1 and the virtual image L2 are combined.

The second combiner 132 is disposed between the second eyeglass 130 and the second vision correction lens 134. The second vision correction lens 134 may also be disposed to be inclined with respect to the second eyeglass 130. As an example, the second combiner 132 and the second vision correction lens 134 may be disposed in parallel to each other. In other words, the second vision correction lens 134 may have the same inclination angle as that of the second combiner 132. The second vision correction lens 134 may be designed to have minimal diopter and astigmatism variations in a configuration including the inclination angle. The first vision correction lens 124 may be designed in the same manner. In an example, either or both of the first vision correction lens 124 and the second vision correction lens 134 may have a uniform thickness and may have a pattern formed to implement optical lens characteristics on a surface thereof.

As shown in an enlarged area A1 where the holder 170 meets the second combiner 132 and the second vision correction lens 134, the upper end of the second combiner 132 is connected to the holder 170. Also, the holder 170 has a protrusion 170a protruding in a direction away from the second eyeglass 130. The protrusion 170a is prepared for coupling the holder 170 with the second vision correction lens 134. The second vision correction lens 134 has an extended portion 134a. The extended portion 134a may be parallel to the second eyeglass 130 or parallel to a direction perpendicular to the holder 170. A groove 134h is formed in a surface of the extended portion 134a that faces the protrusion 170a. The groove 134h is formed to accommodate the protrusion 170a. The coupling of the second vision correction lens 134 and the holder 170 is performed by inserting the protrusion 170a into the groove 134h. The coupling of the first vision correction lens 124 and the holder 170 may also be performed in the same manner as the coupling of the second vision correction lens 134 and the holder 170. The relationship and the arrangement of the second combiner 132 and the second vision correction lens 134 may be equally applied to the relationship and the arrangement of the first combiner 122 and the first vision correction lens 124.

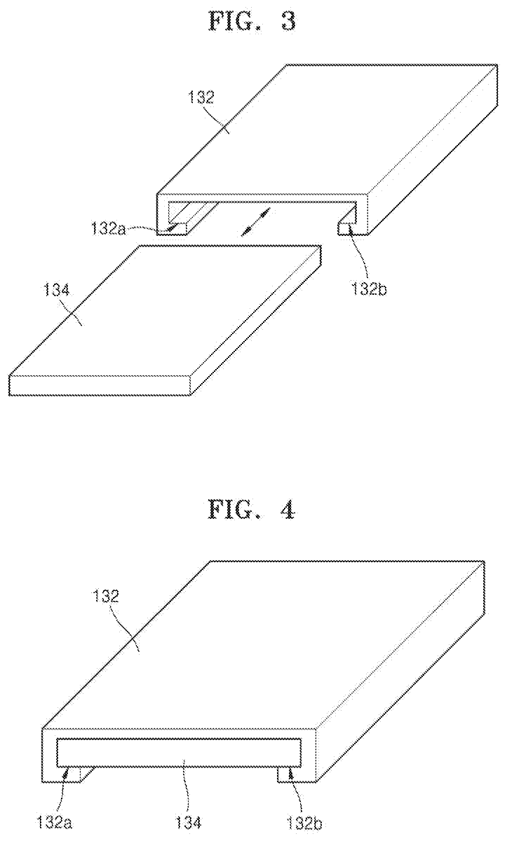

In the augmented reality display device 100, the first and second vision correction lenses 124 and 134 may be coupled on the holder 170 or the first and second combiners 122 and 132 in various ways besides the method described with reference to FIG. 2. For example, as shown in FIG. 3, the second combiner 132 and the second vision correction lens 134 may be coupled to each other in a sliding manner. For this purpose, the second combiner 132 may include first and second grooves 132a and 132b in both sides thereof for sliding the second vision correction lens 134 in a longitudinal direction. When the second combiner 132 and the second vision correction lens 134 are coupled to each other, both sides of the second vision correction lens 134 are inserted into and slide along the first and second grooves 132a and 132b, respectively, and thus, the coupling may be completed. FIG. 4 shows a state that the coupling of the second vision correction lens 134 to the second combiner 132 is completed in a sliding manner. The sliding coupling of the second combiner 132 and the second vision correction lens 134 may likewise be applied to the coupling of the first combiner 122 and the first vision correction lens 124.

FIG. 5 shows an example of the first and second vision correction lenses 124 and 134 of the augmented reality display device 100. FIG. 5 shows an example of one of the first and second vision correction lenses 124 and 134, for example, the second vision correction lens 134. Since the appearances of the first and second vision correction lenses 124 and 134 are the same, the appearance and structural features of the vision correction lens of FIG. 5 may also be applied to the first vision correction lens 124.

Referring to FIG. 5, the second vision correction lens 134 includes a frame 400 and a vision correction lens 410. The vision correction lens 410 may be a lens for correcting the vision of a user so that the user who requires vision correction and who wears the augmented reality display device 100 may normally and clearly view an augmented reality image. In other words, the vision correction lens 410 may be a lens for providing a clear augmented reality image to a user when the user who usually wears glasses takes off the glasses and wears the augmented reality display device 100. Due to the vision correction lens 410, the position where the augmented reality image is formed may be different from the position where the augmented reality image is formed when the vision correction lens 410 does not exist. Therefore, a user who uses the vision correction lens 410 may select the vision correction lens 410 having a focal length suitable for himself considering the focal length of the glasses he wears. The vision correction lens 410 is fixed inside the frame 400. That is, the frame 400 surrounds the vision correction lens 410 and is in close contact with a circumference of the vision correction lens 410. For this purpose, a shape of the frame 400 may be the same as the shape of the vision correction lens 410. The frame 400 includes a horizontal portion and a curved portion connected to the horizontal portion. The frame 400 is directly coupled to the holder 170 when the second vision correction lens 134 is coupled to the holder 170. For this coupling, the frame 400 includes grooves 420 on each side of the horizontal portion. When the second vision correction lens 134 is coupled to the holder 170, the protrusion 170a of the holder 170 is inserted into the groove 420.

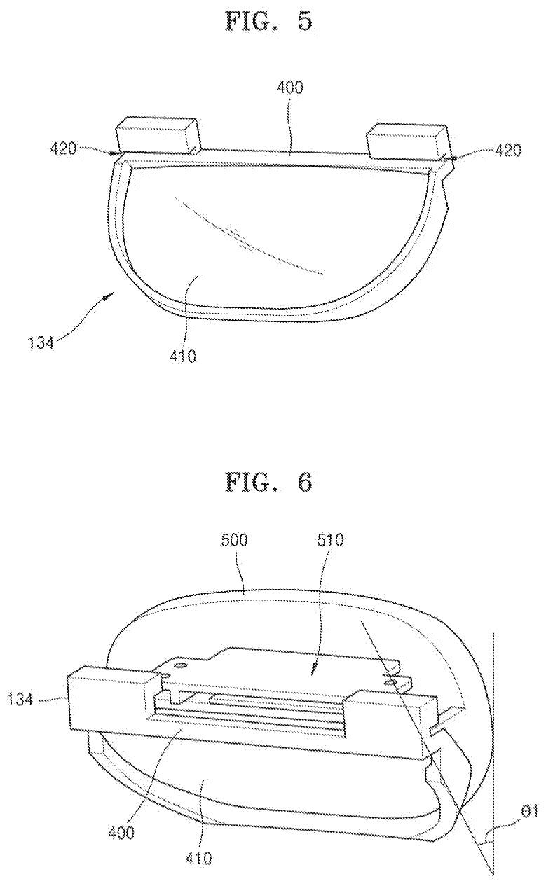

FIG. 6 shows a state in which the second vision correction lens 134 of FIG. 5 is coupled with a holder 500.

Referring to FIG. 6, the second vision correction lens 134 is coupled in an inclined form with the holder 500 which serves as a main frame of the augmented reality display device 100. The holder 500 includes eyeglasses (not shown in FIG. 6) disposed in front of the second vision correction lens 134. An inclination angle 81 of the second vision correction lens 134 with respect to the eyeglass may be, for example, about 35°, but is not limited thereto. Reference numeral 510 denotes a virtual image projector that is connected to the holder 500 behind the holder 500 and supplies a virtual image to be combined with an actual image to the second combiner 132.

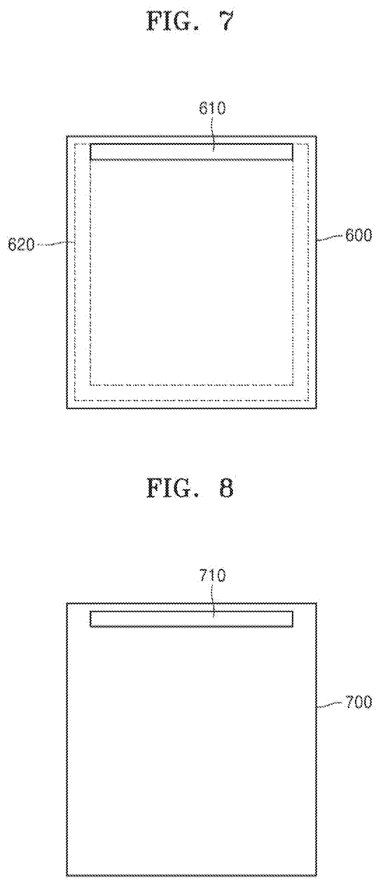

FIG. 7 shows another example of a combiner 600 included in an augmented reality display device according to an embodiment. FIG. 7 shows an appearance of the combiner 600 seen from a user's viewpoint.

Referring to FIG. 7, the combiner 600 includes a magnet 610 in a region of a surface thereof facing the user. For example, the magnet 610 may be disposed on an upper part of the combiner 600. The magnet 610 may extend on other areas of the combiner 600 as long as the magnet 610 does not interfere with the viewing of an augmented reality image. For example, reference numeral 620 denotes a magnet extending along edges of the combiner 600.

FIG. 8 illustrates a case in which a magnet 710 is provided on a surface facing a combiner of a vision correction lens 700 included in an augmented reality display device according to an embodiment.

Referring to FIG. 8, the vision correction lens 700 includes the magnet 710 disposed on an upper surface facing a combiner, for example, the combiner 600 of FIG. 7. The position where the magnet 710 is disposed may correspond to the position of the magnet 610 disposed in the combiner 600. The magnet 710 may be disposed in another area of the surface or may extend to the other area of the surface as long as the magnet 710 does not interfere with viewing the augmented reality image. If the magnet 610 disposed on the combiner 600 is extended as shown by reference numeral 620, the magnet 710 disposed on the vision correction lens 700 may also be provided in an extended form. The magnet 610 of the combiner 600 of FIG. 7 and the magnet 710 of the vision correction lens 700 of FIG. 8 may be provided to be paired with each other. In this case, the magnet 610 of FIG. 7 may be provided in a form of attaching to the surface of the combiner 600, that is, protruding from the surface of the combiner 600, or may be buried (i.e., embedded) in the combiner 600 so that the magnet 610 may not protrude out of the surface of the combiner 600. The magnet 710 provided in the vision correction lens 700 of FIG. 8 may also be provided in the same manner.

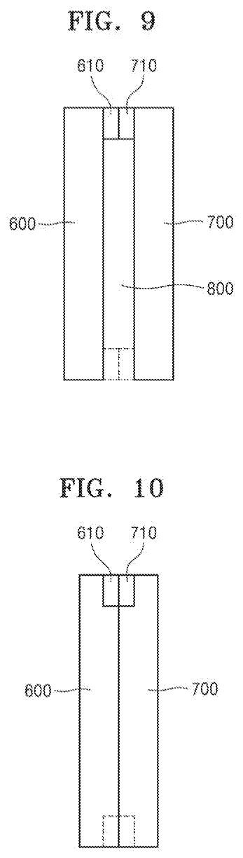

FIGS. 9 and 10 show that the combiner 600 of FIG. 7 and the vision correction lens 700 of FIG. 8 are coupled to each other. FIG. 9 shows a case in which the magnet 610 provided in the combiner 600 and the magnet 710 provided in the vision correction lens 700 protrude from surfaces of the respective combiner 600 and vision correction lens 700, and FIG. 10 shows a case in which the magnets 610 and 710 are buried in the combiner 600 and the vision correction lens 700, respectively.

In FIGS. 9 and 10, dashed lines indicate a case in which the magnets 610 and 710 extend along edges of the combiner 600 and the vision correction lens 700 similar to the magnet 620 shown in FIG. 7.

In the case of FIG. 9, the combiner 600 and the vision correction lens 700 do not directly contact each other, and there is an empty space 800 between the combiner 600 and the vision correction lens 700.

On the other hand, in the case of FIG. 10, since the magnets 610 and 710 are buried, the combiner 600 and the vision correction lens 700 may directly contact each other.

Hereinafter, a case in which both a combiner and a vision correction lens are provided as a single body in an augmented reality display device according to an embodiment will be described.

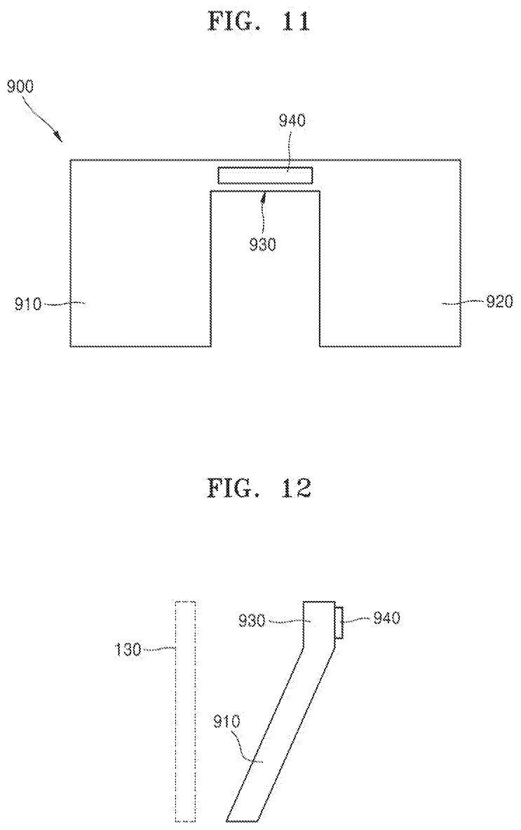

FIG. 11 shows a single body combiner 900 in which a combiner corresponding to the left eye and a combiner corresponding to the right eye are connected to each other. FIG. 11 is a view seen from a user's viewpoint.

Referring to FIG. 11, the single body combiner 900 includes a first combiner 910 corresponding to the left eye of the user, a second combiner 920 corresponding to the right eye of the user, and a connector 930 for connecting the first combiner 910 to the second combiner 920. The first and second combiners 910 and 920 are separated by as much as a horizontal length of the connector 930. A width of the connector 930 in a vertical direction is much less than that of the first and second combiners 910 and 920. A magnet 940 is disposed on a surface of the connector 930. The magnet 940 is an element for coupling the single body combiner 900 with a vision correction lens. Although it is depicted that the magnet 940 is disposed only on the surface of the connector 930, the magnet 940 may be disposed in another region or extend to the another region of the single body combiner 900.

FIG. 12 is a left side view of the single body combiner 900 of FIG. 11. Reference numeral 130 virtually indicates an eyeglass located in front of the single body combiner 900.

Referring to FIG. 12, the first combiner 910 is not parallel to the eyeglass 130. That is, the first combiner 910 is inclined at a given angle with respect to the eyeglass 130. In FIG. 11, since the first and second combiners 910 and 920 are a single body, it may be seen that the second combiner 920 is also inclined with respect to the eyeglass 130 in the same manner as that of the first combiner 910. The connector 930 is parallel to the eyeglass 130. The magnet 940 is attached to a surface of the connector 930 that does not face the eyeglass 130, that is, a surface facing the user. The magnet 940 is in a protruded form, but may be provided in a form buried in the connector 930. The connector 930 is outside a user's field of view. The connector 930 is a holder of the augmented reality display device, that is, a part connected to a main frame.

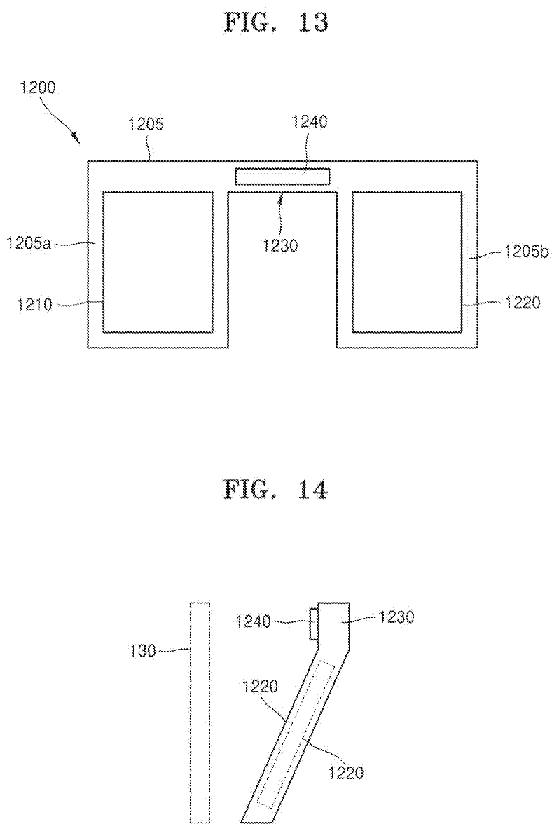

FIG. 13 is a view illustrating a single body vision correction lens tool 1200 included in an augmented reality display device according to an embodiment. FIG. 13 is a front view of the single body vision correction lens tool 1200 seen from the outside.

Referring to FIG. 13, the single body vision correction lens tool 1200 includes a single body frame 1205 and first and second vision correction lenses 1210 and 1220 mounted on the single body frame 1205. The single body frame 1205 includes first and second frames 1205a and 1205b and includes a connector 1230 that connects the first frame 1205a to the second frame 1205b. The first vision correction lens 1210 is mounted on the first frame 1205a, and the second vision correction lens 1220 is mounted on the second frame 1205b. The first vision correction lens 1210 corresponds to the right eye of a user, and the second vision correction lens 1220 corresponds to the left eye of the user. The magnet 1240 may be provided on a surface of the connector 1230 as one of coupling means for coupling with the single body combiner 900 of FIG. 11.

FIG. 14 is a right side view of the single body vision correction lens tool 1200 of FIG. 13. In FIG. 14, reference numeral 130 indicates a virtual eyeglass located in front of the single body vision correction lens tool 1200 for convenience of explanation.

Referring to FIG. 14, the second frame 1205b of the single body vision correction lens tool 1200 is non-parallel with respect to the eyeglass 130 and is inclined at a given angle. A distance between a lower end of the second frame 1205b and the eyeglass 130 is closer than a distance between an upper end of the second frame 1205b and the eyeglass 130. The connector 1230 is parallel to the eyeglass 130. The magnet 1240 is attached to a surface of the connector 1230 facing the eyeglass 130. The magnet 1240 is protruded, but may be buried in the connector 1230.

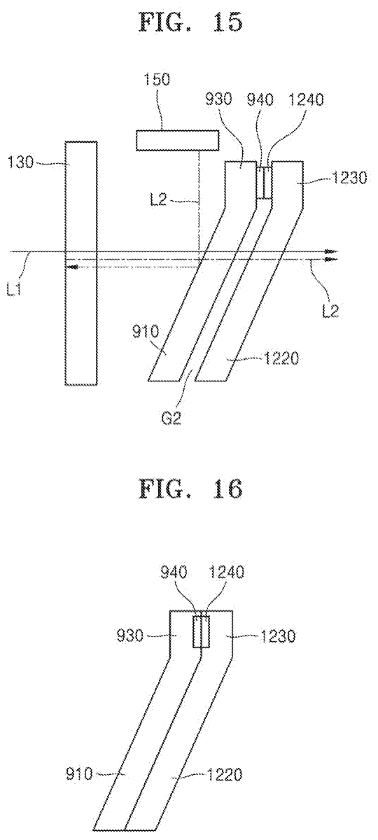

FIGS. 15 and 16 show the coupling of the single body combiner 900 of FIG. 11 and the single body vision correction lens tool 1200 of FIG. 13.

FIG. 15 shows a non-buried type coupling of the magnet 940 attached to a surface of the connector 930 of the single body combiner 900 with the magnet 1240 attached to a surface of the connector 1230 of the single body vision correction lens tool 1200.

Referring to FIG. 15, due to magnetic forces pulling each other between the magnet 940 and the magnet 1240, the magnets 940 and 1240 are coupled to each other, and thus, the coupling between the single body combiner 900 and the single body vision correction lens tool 1200 is performed. An inclination angle of the first combiner 910 of the single body combiner 900 with respect to the eyeglass 130 and an inclination angle of the second vision correction lens 1220 of the single body vision correction lens tool 1200 with respect to the eyeglass 130 may be the same. Accordingly, in a state that the single body combiner 900 and the single body vision correction lens tool 1200 are coupled to each other, the inclination angle of the first combiner 910 of the single body combiner 900, that is, a portion of the single body combiner 900 to which a virtual image is projected from the second virtual image projector 150, may be the same as the inclination angle of the second vision correction lens 1220 of the single body vision correction lens tool 1200. As a result, the first combiner 910 of the single body combiner 900 and the second vision correction lens 1220 of the single body vision correction lens tool 1200 may be parallel to each other. The magnet 940 attached to the single body combiner 900 and the magnet 1240 attached to the single body vision correction lens tool 1200 protrude on surfaces of the respective connectors 930 and 1230, and thus, after the single body combiner 900 and the single body vision correction lens tool 1200 are coupled, the first combiner 910 of the single body combiner 900 and the second vision correction lens 1220 of the single body vision correction lens tool 1200 are separated from each other by a gap G2. That is, there is a parallel gap between the first combiner 910 of the single body combiner 900 and the second vision correction lens 1220 of the single body vision correction lens tool 1200.

The virtual image L2 supplied to the first combiner 910 of the single body combiner 900 from the second virtual image projector 150 is reflected by the first combiner 910 toward the eyeglass 130, and is then reflected back to the first combiner 910 from the eyeglass 130. At this point, the actual image L1 incident through the eyeglass 130 is also incident on the first combiner 910 together with the virtual image L2. The inclined portion, that is, the first combiner 910 of the single body combiner 900, may be a translucent mirror. The real image L1 and the virtual image L2 incident on the first combiner 910 of the single body combiner 900 from the eyeglass 130 enters a user's eye after sequentially passing through the first combiner 910 and the second vision correction lens 1220 of the single body vision correction lens tool 1200. In this way, the user may see augmented reality.

FIG. 16 shows a case of coupling when the magnet 940 attached to the surface of the connector 930 of the single body combiner 900 and the magnet 1240 attached to the surface of the connector 1230 of the single body vision correction lens tool 1200 respectively are buried in the single body combiner 900 and the single body vision correction lens tool 1200, respectively.

Since the magnets 940 and 1240 are both buried, there are no protruding members on the surfaces of the connectors 930 and 1230. Thus, when the single body combiner 900 and the single body vision correction lens tool 1200 are coupled through both the magnets 940 and 1240, the single body combiner 900 and the single body vision correction lens tool 1200 may directly contact each other as depicted in FIG. 16.

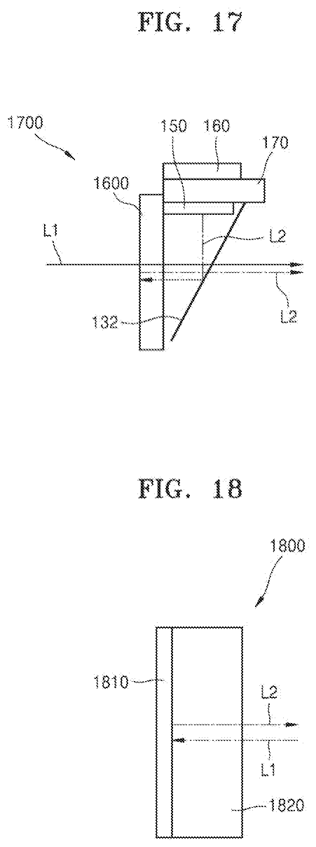

FIG. 17 shows an augmented reality display device 1700 according to an embodiment. Like reference numerals indicate elements that are identical to the elements described above.

Referring to FIG. 17, the augmented reality display device 1700 includes an eyeglass 1600, a combiner 132, the second virtual image projector 150, a virtual image supply unit 160, and a holder 170. A virtual image supply device may be configured by including the second virtual image projector 150 and the virtual image supply unit 160. The holder 170 may be included in the virtual image supply device.

In the case of the augmented reality display device 1700 of FIG. 17, a vision correction lens tool is not included. Instead, the eyeglass 1600 of the augmented reality display device 1700 may have a corrective focal length unlike the second eyeglass 130 described with reference to FIG. 2. In other words, in the case of the augmented reality display device 1700, the eyeglass 1600 may serve as a lens for correcting the vision of a user. Accordingly, the eyeglass 1600 may be an eyeglass having a frequency suitable for vision correction of a user who wears the augmented reality display device 1700. Therefore, in the augmented reality display device 1700 of FIG. 17, the augmented reality display device 1700 may be used without disposing a separate vision correction lens tool between the combiner 132 and the user.

FIG. 18 shows an example of an eyeglass 1800 included in the augmented reality display devices 100 and 1700 described above.

Referring to FIG. 18, the eyeglass 1800 includes an eyeglass body 1820 and a reflective coating film 1810 covering a front surface of the eyeglass body 1820. The eyeglass body 1820 may perform as a lens or may not perform as a lens. The reflective coating film 1810 may reflect a virtual image L2 incident from a right side of the eyeglass 1800 as shown in FIG. 18 back toward the eyes of the user.

In an augmented reality display device according to an embodiment, a combiner to which a virtual image is projected is disposed to be inclined with respect to an eyeglass, and a vision correction lens (frequency clip) is disposed parallel to the combiner. That is, the vision correction lens is also inclined with respect to the eyeglass. As a result, a compact structural design is possible and wearing comfort may be improved compared with the case in which a vision correction lens of the related art is disposed in parallel to an eyeglass.

It should be understood that embodiments described herein should be considered in a descriptive sense only and not for purposes of limitation. Descriptions of features or aspects within each embodiment should typically be considered as available for other similar features or aspects in other embodiments. While one or more embodiments have been described with reference to the figures, it will be understood by those of ordinary skill in the art that various changes in form and details may be made therein without departing from the spirit and scope as defined by the following claims.

What is claimed is:

1. An augmented reality display device comprising:
an eyeglass;
an optical combining element disposed to be inclined with respect to the eyeglass;
a virtual image supply unit supplying a virtual image to the optical combining element; and
a vision correction lens disposed with an inclination angle with respect to the eyeglass.

2. The augmented reality display device of claim 1, wherein the vision correction lens and the optical combining element are disposed parallel to each other.

3. The augmented reality display device of claim 1, wherein a coupling portion of the vision correction lens includes a groove.

4. The augmented reality display device of claim 1, wherein the optical combining element and the vision correction lens are coupled to each other via a magnet.

5. The augmented reality display device of claim 1, wherein the optical combining element and the vision correction lens are coupled in a sliding manner.

6. The augmented reality display device of claim 1,
wherein the eyeglass comprises:
a first eyeglass; and
a second eyeglass,
wherein the optical combining element comprises:
a first optical combining element corresponding to the first eyeglass; and
a second optical combining element corresponding to the second eyeglass, and
wherein the vision correction lens comprises:
a first vision correction lens corresponding to the first optical combining element; and
a second vision correction lens corresponding to the second optical combining element.

7. The augmented reality display device of claim 1, wherein the optical combining element comprises a portion parallel to the eyeglass.

8. The augmented reality display device of claim 1, wherein the vision correction lens is mounted on a frame disposed with the inclination angle with respect to the eyeglass, and
wherein the frame comprises a portion parallel to the eyeglass.

9. The augmented reality display device of claim 6, wherein the optical combining element comprises a single body optical combining element comprising:
the first optical combining element;
the second optical combining element; and
a connector connecting the first optical combining element to the second optical combining element.

10. The augmented reality display device of claim 6, wherein the first vision correction lens and the second vision correction lens are coupled to the optical combining element independently from each other.

11. The augmented reality display device of claim 9, further comprising a single body frame comprising:
a first frame mounted on the first eyeglass;
a second frame mounted on the second eyeglass; and
a frame connector connecting the first frame to the second frame.

12. The augmented reality display device of claim 11, wherein the single body optical combining element and the single body frame are coupled via a magnet.

13. The augmented reality display device of claim 4, wherein the magnet is embedded within at least one from among the optical combining element and the vision correction lens.

14. The augmented reality display device of claim 9, wherein the first vision correction lens and the second vision correction lens are coupled to the optical combining element independently from each other.

15. The augmented reality display device of claim 12, wherein the magnet is embedded within at least one from among the single body optical combining element and the single body frame.

16. An augmented reality display device comprising:
an eyeglass having a corrective focal length;
an optical combining element disposed to be inclined with respect to the eyeglass; and
a virtual image supply unit supplying a virtual image to the optical combining element.
